(19) United States
(12) Patent Application Publication
(10) Pub. No.: US 2006/0220372 A1
(43) Pub. Date: Oct. 5, 2006

(54) Scrapbook workstation

(76) Inventor: George Shackelford, Murrietta, CA (US)

Correspondence Address: DONALD D. MON;ATTORNEY AT LAW, SUITE 303, 750 EAST GREEN STREET, PASADENA, CA, 91101, US

(21) Appl. No.: 11/084,699

(22) Filed: Mar. 18, 2005

(51) Int. Cl. B42D 1/00

(52) U.S. Cl. 281/15.1

(57) ABSTRACT

A scrapbook workstation having a planar work surface accommodating storage, providing dimensional and alignment references, and ready disposal of scrap.

### FIELD OF THE INVENTION

A workstation for the preparer of scrapbook pages.

### BACKGROUND OF THE INVENTION

A good scrapbook page needs to look good in the sense of orderliness and balance. This means skill and artistry in arrangement of often irregularly shaped items, which in turn require a stable support that provides dimensional and angular alignment information, means to dispose quickly of scrap material, and ready availability of instruments and tools. All of this must be accomplished on a rather small surface which must be usefully smooth, but also permit easy sliding movement along the surface, and easy pick-up from it.

It is the objective of this invention to provide such a workstation.

### BRIEF DESCRIPTION OF THE INVENTION

A scrapbook accessory according to this invention includes a rigid base having a top planar work surface. The work surface is bounded by an edge which bears on a plurality of its sides linear measurement indicia. The surface itself is lightly patterned by reliefs which discourage adherence of items to the surface.

A waste aperture extends from the surface through the base to pass a receptacle so that scrap material can readily be dumped from the surface into the receptacle simply by scraping it into the receptacle.

According to a preferred but optional feature of the invention, the aperture is located adjacent to the edge of the base near where a user will be located.

According to yet another feature of the invention, a collection groove extends adjacent to an edge of the base so as to hold tools and accessories such as clips and knives.

According to yet another optional feature of the invention, the bottom side of the base (from the work surface) is provided with a skid-resistant layer that can serve to restrain the workstation from sliding off of the lap of a user or on a table.

The above and other features of this invention will be fully understood from the following detailed description and the accompanying drawings, in which:

### BRIEF DESCRIPTION OF THE DRAWINGS

FIG. 1 is an isometric view looking at the top of a workstation according to this invention with a collective receptacle installed;

FIG. 2 is an exploded view of FIG. 1;

FIG. 3 is a top view of the device of FIG. 1;

FIG. 4 is a bottom view of FIG. 3; and

FIG. 5 is a cross-section taken at line 5-5 in FIG. 3.

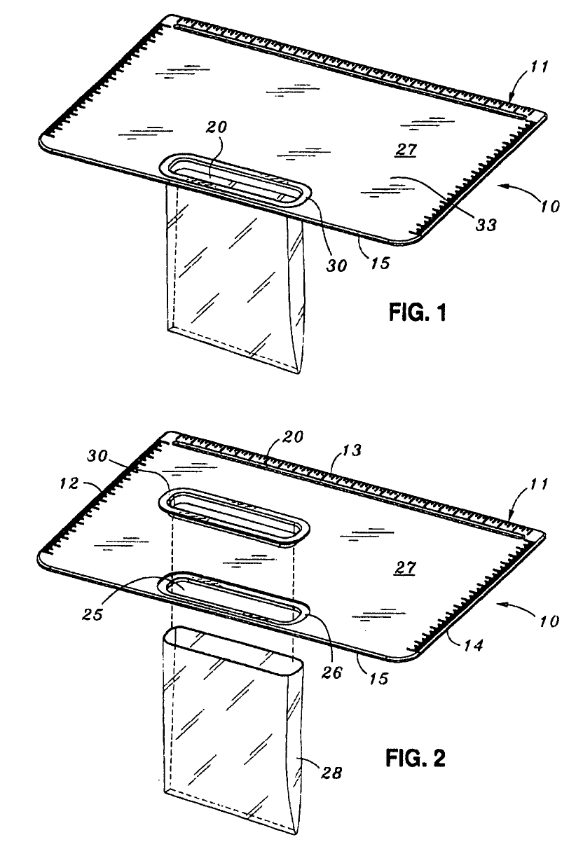

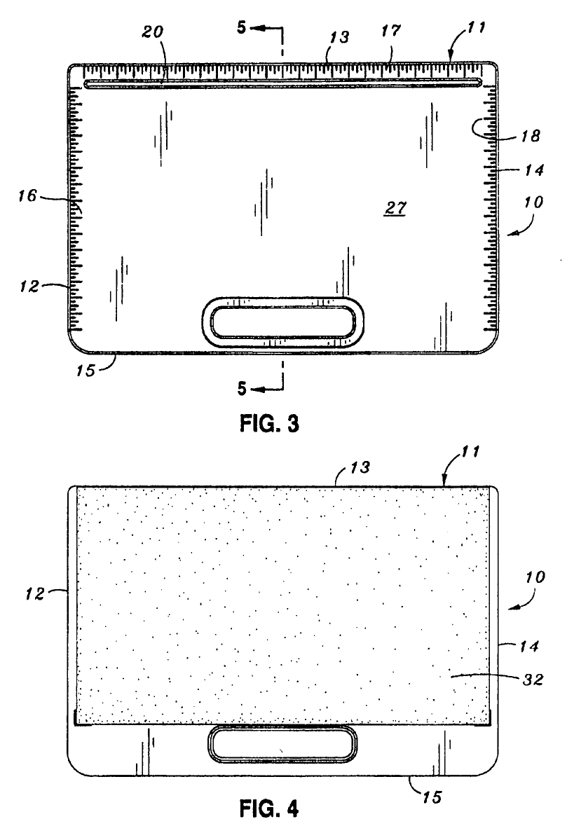

### DETAILED DESCRIPTION OF THE INVENTION

Scrapbook workstation 10 comprises a rigid base 11 which is preferably generally rectangular. Three of its edges 12, 13 and 14 have straight edges. Edge 15, which will be closest to the user, is also preferably straight, but could instead be shaped so as to conform to the user's body.

Edges 12, 13 and 14 have linear measurement indicia 16, 17, 18 respectively so the user can conveniently measure, align and orient the various items he wishes to incorporate in the scrapbook page. Edges 12 and 14 are parallel. Edge 13 is normal to them. The indicia may be in any unit of measurements, but usually inches or centimeters will be the scale.

A collection groove 20 may be aligned with any of the edges, but usually will be located along edge 13 inwardly of indicia 17. This groove can be used to collect small scrap, or to hold small useful items such as clips, clamps, brushes, or staples. It may be relatively shallow, but deep enough to hold desired articles. Such a groove can also be provided along any of the other edges, also.

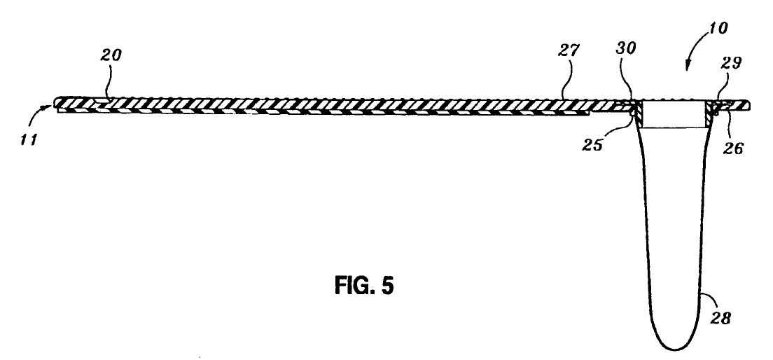

A waste aperture 25 is formed through the base, preferably adjacent to one of the sides. Most conveniently it will be located adjacent to side 15, closest to the user. As best shown in FIG. 5, a recessed step 26 is formed around it, beneath top surface 27 of the base.

A bag 28 with a flange 29 (or merely extra material) may be passed through aperture 25. The flange or material will be held by a retainer 30 pressed into the aperture and upon the flange or material. Thus, the bag hangs below the base and receives scrap. It will be observed that retainer 30 also has a flange 31 that fairs neatly onto the top surface so as not to impede scrap as it pushed toward the aperture.

The bag is thereby readily installed, removed, and replaced.

As best shown in FIG. 4, the bottom side 32 of the base can be faced with friction type material such as rubber or a plastic foam to prevent the device from skidding around.

The top side of the base may advantageously be mildly roughened or relieved to facilitate lifting of flat items, especially pictures and flat paper items which would tend to be difficult to raise off of a perfectly flat (mirror flat) surface. It is necessary that what could be considered roughness not be so rough as to impede smooth writing and smoothing of articles to be mounted. Very light “pebbling.” or shallow grooving are suitable examples.

There results a very convenient scrapbook workstation, convenient to use and service, with provisions for accuracy of work, accessibility of tooling and supplies, and convenient in disposed of scrap.

This invention is not to be limited by the embodiment shown in the drawings and described in the description, which is given by way of example and not of limitation, but only in accordance with the scope of the appended claims.

I claim:

1. A scrapbook workstation comprising a base having a planar top work surface bonded by a plurality of edges, first and second linear measurement indicia spaced apart from and parallel to each other, extending adjacent to respective said edges, and a third linear measurement indicia extending adjacent to another of said edges, normal to said first and second indicia, a groove in said work surface extending parallel to one of said edges to receive useful items, a scrap aperture through said base adjacent to one of said edges, a bag extending through said aperture and held to said top work surface by a retainer, and a pad of friction material adherent to said base on its side opposite from said work surface.

2. A scrapbook workstation according to claim 1 in which said base is substantially rectangular, and said indicia are parallel to respective edges.

3. A scrapbook according to claim 1 in which said work surface is relieved to enable flat items more readily to be picked up off of said surface.

4. A scrapbook according to claim 1 in which a step recessed into said top surface is adapted to receive a portion of a collection bag, and in which a retainer clamps, said bag to said step, said retainer including a flange to be laid on the said work surface, smooth at its edges to enable the convenient movement of scrap into the bag.

5. A scrapbook according to claim 1 in which a waste aperture passes through said base to receive a bag to be held in said aperture and receive scrap.

6. A scrapbook according to claim 5 in which a peripheral step is formed in said top surface, and a retainer presses an edge of said bag against said step to hold the bag in place.

7. A scrapbook according to claim 6 in which said retainer includes a flange that bears against said top surface with an edge that fairs into said top surface.

8. A scrapbook according to claim 7 in which said work surface is relieved to enable flat items more readily to be picked up off of said surface.
